(19) United States
(12) Patent Application Publication
(10) Pub. No.: US 2010/0181913 A1
(43) Pub. Date: Jul. 22, 2010

(54) COLD CATHODE ILLUMINATION APPARATUS

(76) Inventor: Chung-Jyh LIN, Taina County (TW)

Correspondence Address: BIRCH STEWART KOLASCH & BIRCH, PO BOX 747, FALLS CHURCH, VA, 22040-0747, US

(21) Appl. No.: 12/688,232

(22) Filed: Jan. 15, 2010

(30) Foreign Application Priority Data
Jan. 19, 2009 (TW) 098101954
Mar. 19, 2009 (TW) 098109001

(51) Int. Cl. H01J 13/46

(52) U.S. Cl. 315/70

(57) ABSTRACT

A cold cathode illumination apparatus applied with an alternative current includes a tube, at least one electrical connection element, a voltage transforming element, a cold cathode fluorescent lamp (CCFL) and a strip element. At least one part of the tube is light-permeable. The electrical connection element is disposed at one end of the tube. The voltage transforming element is disposed in the tube and electrically connected with the electrical connection element. The CCFL is disposed in the tube and electrically connected with the voltage transforming element. The strip element is disposed along and in the tube. The CCFL is connected with the strip element. The strip element has a reflective surface above which the CCFL is disposed.

### CROSS REFERENCE TO RELATED APPLICATIONS

This Non-provisional application claims priority under 35 U.S.C. §119(a) on Patent Application No(s). 098101954 and 098109001 filed in Republic of China on Jan. 19, 2009 and Mar. 19, 2009, the entire contents of which are hereby incorporated by reference.

### BACKGROUND OF THE INVENTION

1. Field of Invention

The invention relates to an illumination apparatus and, in particular, to a cold cathode illumination apparatus.

2. Related Art

With the progress of technology, illumination apparatuses have become indispensible electric equipment in our daily life. Among present technologies, most illumination apparatuses use hot cathode fluorescent lamps (HCFL) as the lighting source.

FIG. 1 is a schematic view of a conventional HCFL 1 cooperated with a lamp base B. The HCFL 1 has a glass tube 11, two filaments 12 and two electrical connection elements 13. Argon which is easy to discharge and a few amount of mercury are introduced into the glass tube 11, and a fluorescent material is coated at the internal wall of the glass tube 11. The filaments 12 are disposed at two ends of the glass tube 11 respectively. The filaments 12 can be made of wolfram as an electrode on which the material capable of emitting electrons are coated. Each electrical connection element 13 has a lamp cap 131 and two electrical pins 132. The HCFL 1 is electrically connected with an alternative current power source through the electrical pins, and has a stable current produced by an electronic ballast. The electronic ballast also preheats the filaments of the HCFL 1 for lighting up. In the beginning of the lighting up, the current flows through the filament 12, so that the filaments 12 are heated to emit the electrons which collides with the mercury atoms in the glass tube 11. Ultraviolet rays are thus generated and excite the fluorescent material in the glass tube 11 for emitting visible light.

However, due to a long period of preheating the filaments 12 of the HCFL 1, the lighting up is tardy. Besides, some drawbacks of HCFL 1, such as short lifespan, difficulty in dimming and inability to turn on and off frequently, all make users inconvenient in usage.

Therefore, it is an important subject to provide an illumination apparatus that is prompt in lighting up and has a long lifespan.

### SUMMARY OF THE INVENTION

In view of the foregoing subject, an object of the invention is to provide an illumination apparatus that is prompt in lighting up and has a long lifespan.

To achieve the above object, the invention discloses a cold cathode illumination apparatus applied with an alternative current. The cold cathode illumination apparatus includes a tube, at least one electrical connection element, a voltage transforming element, at least one cold cathode fluorescent lamp (CCFL) and a strip element. At least one part of the tube is light-permeable. The electrical connection element is disposed at one end of the tube. The voltage transforming element is disposed in the tube and electrically connected with the electrical connection element. The CCFL is disposed in the tube and electrically connected with the voltage transforming element. The strip element is disposed along and in the tube. The CCFL is connected with the strip element. The strip element has a reflective surface above which the CCFL is disposed.

As mentioned above, the cold cathode illumination apparatus according to the invention has a tube in which at least one CCFL is disposed. Because the electrode of the CCFL is not made of wolfram, the lighting up speed of the CCFL is prompter than that of HCFL. In addition, the CCFL has other advantages, such as long lifespan, and capability of dimming and ability to turn on and off frequently and rapidly. Besides, the reflective surface of the string element can reflect the downward light emitted by the CCFL to the upside to improve the efficiency of the light usage.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional HCFL cooperated with a lamp base;

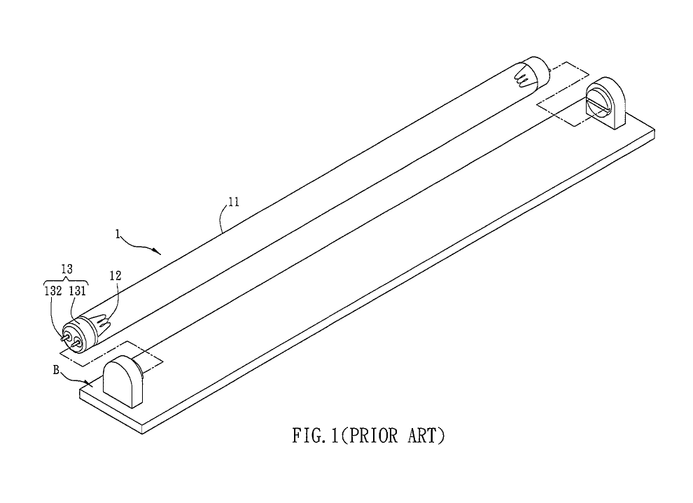

FIG. 2A is a schematic view of a cold cathode illumination apparatus according to the first embodiment of the invention;

FIG. 2B is a sectional view of the cold cathode illumination apparatus taken along the section A-A in FIG. 2A;

FIG. 2C is a sectional view of another modified case of the cold cathode illumination apparatus according to the first embodiment of the invention;

FIGS. 3A and 3B are sectional views of different cold cathode illumination apparatuses according to the first embodiment of the invention;

FIGS. 3C and 4 are schematic views of different cold cathode illumination apparatuses according to the first embodiment of the invention;

FIGS. 3D and 3E are sectional views of different cold cathode illumination apparatuses according to the first embodiment of the invention;

FIG. 5 is a schematic view of a cold cathode illumination apparatus according to the second embodiment of the invention;

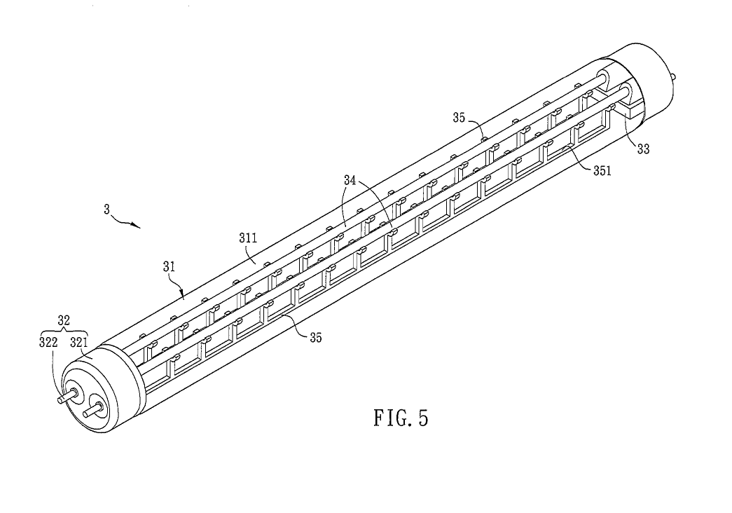

FIG. 6A is a schematic view of a cold cathode illumination apparatus according to the third embodiment of the invention cooperated with a lamp base;

FIG. 6B is a sectional view of the cold cathode illumination apparatus taken along the section B-B in FIG. 6A;

FIGS. 7 and 8 are schematic views of different cold cathode illumination apparatuses according to the third embodiment of the invention;

FIGS. 9A and 9B are sectional views of different cold cathode illumination apparatuses according to the third embodiment of the invention; and

FIG. 10 is a schematic view of a cold cathode illumination apparatus according to the fourth embodiment of the invention.

### DETAILED DESCRIPTION OF THE INVENTION

The present invention will be apparent from the following detailed description, which proceeds with reference to the accompanying drawings, wherein the same references relate to the same elements.

### First Embodiment

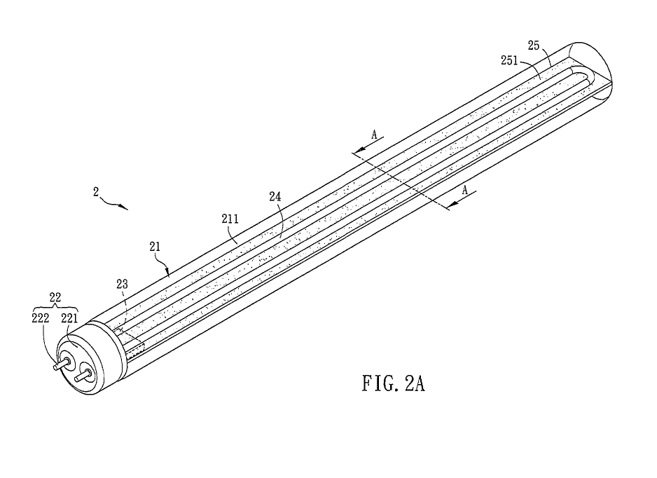

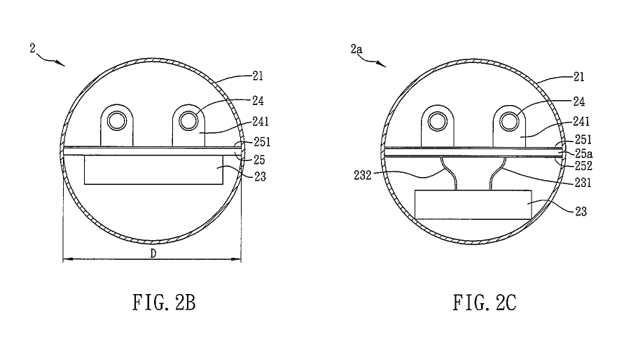

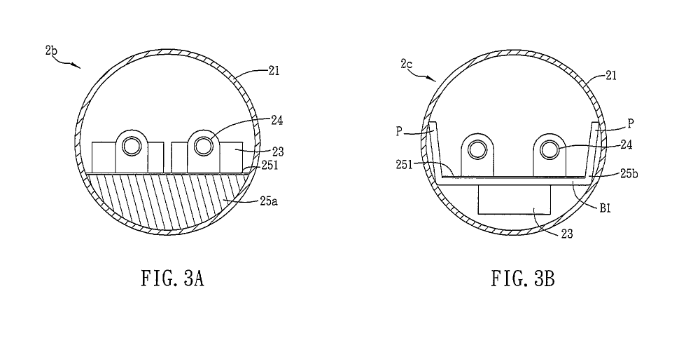

FIG. 2A is a schematic view of a cold cathode illumination apparatus 2 according the first embodiment of the invention, and FIG. 2B is a sectional diagram taken along the section A-A in FIG. 2A. Referring to FIGS. 2A and 2B, the cold cathode illumination apparatus 2 is applied with an alternative current (AC), which is, for example, the AC with 60 Hz supplied from the city power or the AC outputted by other electronic devices such as inverters, electronic ballasts and electromagnetic ballasts. To be noted, the AC compliant with high frequency, low frequency or other frequencies is applicable. Among them, the high frequency range may be between 1 KHz and 1000 KHz, and is preferably between 20 KHz and 30 KHz or between 40 KHz and 70 KHz.

The cold cathode illumination apparatus 2 includes a tube 21, at least one electrical connection element 22, a voltage transforming element 23, a CCFL 24 and a strip element 25.

At least a part of the tube 21 is light-permeable. The tube 21 may be made, for example, of glass, ceramics, quartz, plastics or polymer material. The cross-section of the tube 21 may be, for example, circular, semi-circular, elliptic, square, rectangular or polygonal. In the embodiment, the tube 21 exemplarily is all light-permeable and the section of the tube 21 is circular. Besides, one end of the tube 21 is open, and the other end of the tube 21 is sealed, for example.

The electrical connection element 22 is disposed at one end of the tube 21. In the embodiment, the cold cathode illumination apparatus 2 only has an electrical connection element 22 which can has a lamp cap 221 and two electrical pins 222. The electrical pins 222 are fixed to the lamp cap 221 and protruded from the lamp cap 221. The lamp cap 221 is connected with the tube 21 by adhesion, wedging or screwing, for example.

The voltage transforming element 23 includes a transformer for example. The voltage transforming element 23 is disposed in the tube 21, and may be adhered to the internal wall of the tube 21, for example. The voltage transforming element 23 is electrically connected with the electrical connection element 22. Alternatively, the voltage transforming element 23 can be replaced with an inverter depending on the practical situation. In this case, the voltage transforming element 23 is the voltage transforming element inside the inverter. Besides the voltage transforming element 23, the inverter may include a bridge rectifier to convert AC to direct current (DC) and/or a transistor as a switch for converting DC to AC.

Furthermore, the tube 21 can have a light-permeable portion 211, and the voltage transforming element 23 is disposed corresponding to the light-permeable portion 211. In other words, the voltage transforming element 23 is correspondingly disposed in the light-permeable area. Therefore, it is unnecessary to add a light-shielding area or enlarge the lamp cap to locate the voltage transforming element 23, thereby increasing the light-permeable area of the cold cathode illumination apparatus 2.

The CCFL 24 can be U-shaped, C-shaped, W-shaped or linear, for example. In the embodiment, the CCFL 24 is U-shaped. The CCFL 24 is disposed in the tube 21, and electrically connected to the voltage transforming element 23. The voltage transforming element 23 receives the AC power, and then the AC power is boosted for driving the CCFL 24. The CCFL 24 can have a protection element 241 at one end of the CCFL 24. The protection element 241 may be made non-conductive material such as rubber. The protection element 241 can prevent the electrode pins of the CCFL 24 from damage, and separate two electrode pins lest they are short circuited.

Because the CCFL 24 is not configured with filament, the lighting up thereof is faster than the conventional HCFL. Besides, the CCFL 24 has more advantages, such as long lifespan, capability of dimming and ability to turn on and off frequently.

The strip element 25 is disposed along and in the tube 21. That is, a length direction of the strip element 25 is substantially parallel to that of the tube 21. The length of the strip element 25 is larger than half the length of the CCFL 24, and preferably is not less than the length of the CCFL 24. The CCFL 24 is connected with the strip element 25. For example, the CCFL 24 is disposed on the strip element 25, so that the strip element 25 can support the CCFL 24. The strip element 25 may be made of opaque material, transparent material, electric conductive material or insulating material, and can be connected to the electrical connection element 22 by wedging, adhesion, or embedding, for example. Alternatively, the strip element 25 can be wedged to and fixed in the tube 21, for example, when the width D of the strip element 25 is substantially the same as the internal diameter of the tube 21 as shown in FIG. 2B, so that it is unnecessary to fix the strip element 25 with the electrical connection element 22.

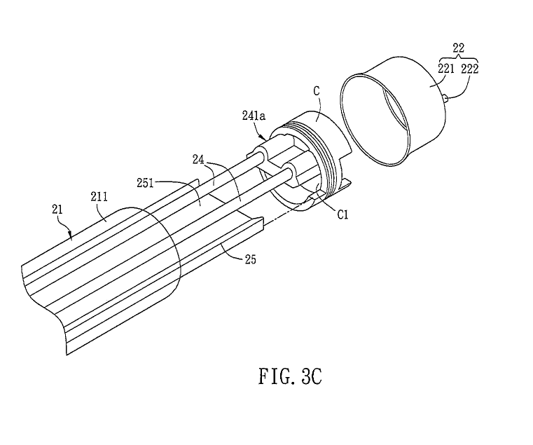

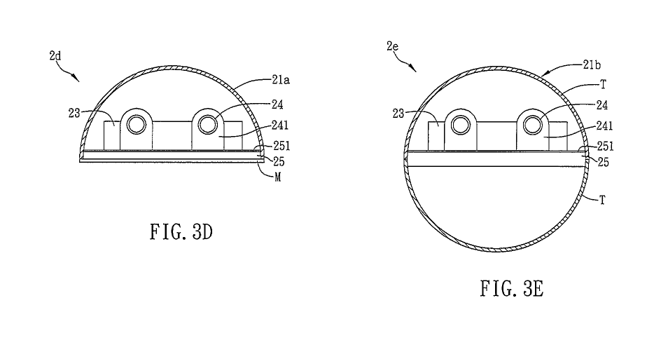

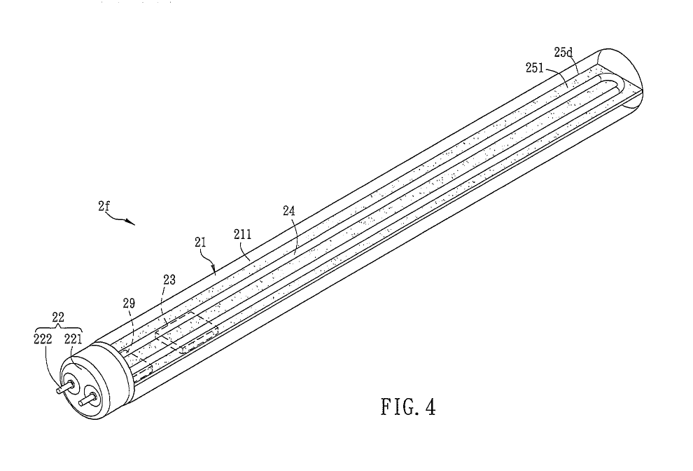

The strip elements 25, 25a and 25b can be flat-shaped (see FIG. 2B), arc-shaped in section (see FIG. 3A), or U-shaped (see FIG. 3B). As shown in FIG. 3B, the strip element 25b can has a main body B1 and at least one light-adjusting portion P which is disposed adjacent to the CCFL 24. An included angle is formed between the light-adjusting portion P and the main body B1. Therefore, through the adjustment of the included angle and the arrangement of the reflective material, the light emitted by the CCFL 24 can be guided to the desired direction with a good directionality.

As shown in FIG. 3C, the protection element 241a of the CCFL 24a can be integrally formed with a wedging portion C, which is adaptive to the tube 21 in shape, by injection molding for example. The wedging portion C has a wedging opening C1, and the strip element 25 can be wedged to the wedging opening C1. One side of the wedging portion C is connected to the protection element 241a, and the other side thereof is connected to the lamp cap 221. For example, the wedging portion C is made of a flexible material and can be pressed into the lamp cap 221. Therefore, the wedging portion C can connect the tube 21, the strip element 25 and the lamp cap 221, respectively.

As shown in FIG. 3D, the section of the tube 21a is semicircular, and the voltage transforming element 23 and the CCFL 24 are disposed at the same side of the strip element 25, thereby decreasing the material cost of the tube 21a of the cold cathode illumination apparatus 2d. Besides, as shown in FIG. 3D, a flat side of the tube 21a can be connected with a circuit board or a metal board M to enhance the heat dissipation. Referring to FIG. 3E, the tube 21b of the cold cathode illumination apparatus 2e can be consisted of several components. For example, the tube 21b can be formed by connecting two sub-tubes T, which have semicircular cross-section, by wedging, adhering or buckling.

Referring to FIGS. 2A and 2B, the voltage transforming element 23 and the CCFL 24 can be disposed at two opposite sides of the strip element 25 respectively, so that the strip element 25 can be used to separate the voltage transforming element 23 and the CCFL 24. The CCFL 24 can be electrically connected with the voltage transforming element 23 through a wire, or by directly welding the electrodes of the CCFL 24 to the voltage transforming element 23. The voltage transforming element 23 can be electrically connected with the electrode pins 222 through a wire or direct welding.

In the embodiment, the strip element 25 can further include a reflective surface 251 above which the CCFL 24 is disposed. The reflective surface 251 can be made of a reflective layer or a reflective sheet. The reflective surface 251 of the string element 25 can reflect the downward light emitted by the CCFL 24 to the upside so as to improve the efficiency of the light usage.

FIG. 2C is a sectional view of another aspect of the cold cathode illumination apparatus 2a according to the embodiment. The strip element 25a further has a circuit layer 252, and that is, the strip element 25a is a strip circuit board. The voltage transforming element 23 is directly adhered to the internal wall of the tube 21, and electrically connected to the circuit layer 252 and the electrode pins (not shown in FIG. 2C) through wires 231 and 232, respectively. To be noted, the circuit layer 252 can be disposed on the strip element 25 and located at the opposite side of the reflective surface 251. Alternatively, the circuit layer 252 can be disposed at the same side as the reflective surface 251. In this case, the area of the reflective surface corresponding to the circuit layer forms an opening, for example. Besides, the circuit layer 252 can be disposed inside the strip element 25.

As shown in FIGS. 2A and 2B, because the CCFL 24 is not configured with filaments, the lighting up speed of the CCFL 24 is prompter than that of the HCFL. In addition, the CCFL has more advantages, such as long lifespan, capability of dimming control and ability to turn on and off frequently. Furthermore, the cold cathode illumination apparatus 2 can be directly connected to the present electronic ballast, and driven by the high frequency power outputted from the electronic ballast. In other words, if the electronic ballast is installed in the lamp base of the conventional HCFL, the HCFL can be directly replaced by the cold cathode illumination apparatus 2 of the embodiment, thereby increasing the usage convenience and saving the cost of altering the related circuit. On the other hand, if the conventional electromagnetic ballast is installed in the lamp base of the HCFL, an inverter having the voltage transforming element 23 can be applied in the cold cathode illumination apparatuses 2, 2a, 2b, 2c of this embodiment, so that the replacement of the HCFLs can be directly easily achieved by alteration of the circuit. Besides, the inverter is capable of dimming control, so that the cold cathode illumination apparatus 2 of the embodiment is capable of dimming.

FIG. 4 shows another aspect of the cold cathode illumination apparatus of the embodiment. The cold cathode illumination apparatus 2f can further include an inverter 29 which is directly disposed in the tube 21 and electrically connected with the voltage transforming element 23. The strip element 25d is a circuit board. Both of the voltage transforming element 23 and the inverter 29 are disposed on the strip element 25d, and located at the side opposite to the CCFL 24. Of course, the inverter 29 may not be disposed on the strip element 25d. For example, the inverter 29 can be disposed on another circuit board, or the inverter circuit can be another circuit board.

Therefore, when the HCFL is directly replaced by the cold cathode illumination apparatus 2f of the embodiment, the conventional electromagnetic ballast can be removed or remained. This not only saves the cost of altering the circuit but also makes users more convenient in self-installation. Besides, the reflective surface 251 of the strip element 25d can improve the unit illumination of the cold cathode illumination apparatus 2f. Comparing with the HCFL of the same illumination, the cold cathode illumination apparatus 2f of the embodiment can have less power consumption.

### Second Embodiment

FIG. 3 shows a cold cathode illumination apparatus 3 according to the second embodiment of the invention. The main difference between the cold cathode illumination apparatus 3 and the first embodiment is that the cold cathode illumination apparatus 3 includes two electrical connection elements 32, which are disposed at two ends of the tube 31 respectively, and each electrical connection element 32 has a lamp cap 321 and two electrode pins 322. Besides, the cold cathode illumination apparatus 3 further has two linear CCFLs 34 and two strip elements 35. The CCFLs 34 are adhered to the tube 31 parallely. Each of the strip elements 35 has a Y-shaped cross-section, and is used as the supporter of the CCFL 34.

Therefore, the cold cathode illumination apparatus 3 can be directly connected to the present electronic ballast, and receive the high frequency power outputted by the electronic ballast, thereby enhancing the usage convenience and saving the cost of altering the circuit. In addition, for cooperating with the conventional electromagnetic ballast, an inverter may be added in the cold cathode illumination apparatus 3 and electrically connected to the voltage transforming element 33, or an inverter is used to replace the voltage transforming element 33 (i.e. the voltage transforming element 33 is a part of the inverter), thereby achieving the direct replacement of the HCFL by circuit alteration. Besides, the inverter is capable of dimming control, so that the cold cathode illumination apparatus 3 of the embodiment has a dimming function. Moreover, the cold cathode illumination apparatus 3 can enhance the illumination by using plural CCFLs 34.

To be noted, the electrode pins disposed at two ends of the conventional HCFL are used to heat the filaments. Although the voltage received by the electrode pins is low, the voltage difference between the ends is large. If the cold cathode illumination apparatus 3 is directly disposed on the lamp base of the conventional HCFL and the power is feeding to the electrode pins 322 of two ends, it is easy to produce the intense heat and make the load and the electronic ballast be burned out. Therefore, the cold cathode illumination apparatus 3 according to the embodiment is single-end power feeding for safety. That is, one of the electrical connection elements 32 is for power feeding, and the other is for power releasing. In this case, the electrical connection element 32 disposed at the same side as the voltage transforming element 33 is used for power feeding. Alternatively, the cold cathode illumination apparatus 3 can be dual-ends power feeding.

To be noted, the amount and the arrangement of the CCFLs 34 are not restrictive. For example, the amount of the CCFLs 34 and the strip elements 35 may be two or more, and may be changed according to product demands.

### Third Embodiment

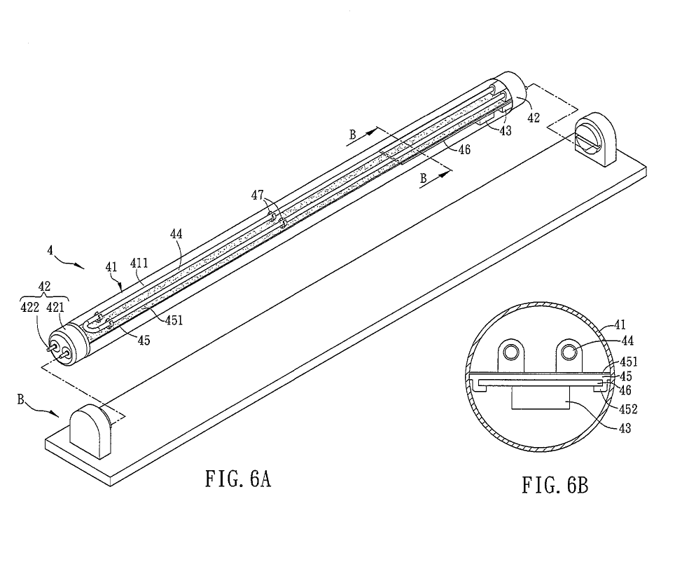

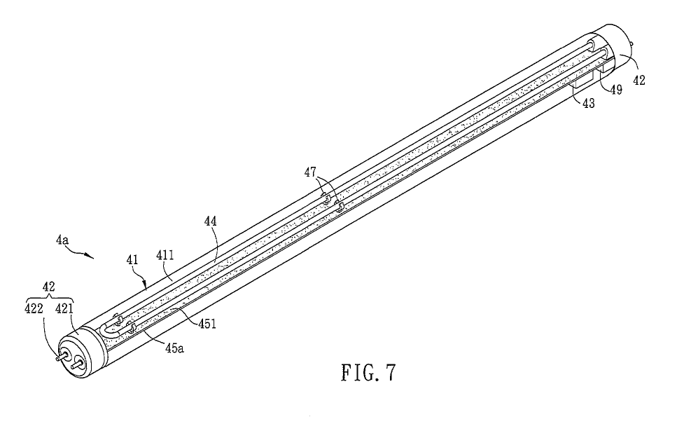

FIG. 6A is a schematic view of the cold cathode illumination apparatus 4 cooperated with the lamp base B, and FIG. 6B is a sectional view of the cold cathode illumination apparatus 4 taken along the section B-B in FIG. 6A. As shown in FIGS. 6A and 6B, the main difference between the cold cathode illumination apparatus 4 of the third embodiment and the first embodiment is that the cold cathode illumination apparatus 4 includes two electrical connection elements 42 which are disposed at two ends of the tube 41 respectively, and each electrical connection element 32 has a lamp cap 421 and two electrode pins 422. Besides, the cold cathode illumination apparatus 4 can further have at least one circuit board 46 and at least one supporting element 47.

The circuit board 46 is disposed in the tube 41, and located at the side opposite to the CCFL 44, for example. Of course, the circuit board 46 can be disposed at the same side as the CCFL 44. The tube 41 can have a light-permeable portion 411, and at least a part of the circuit board 46 is disposed corresponding to the light-permeable portion 411. In other words, at least a part of circuit board 46 is disposed in the light-permeable area of the tube 41. Therefore, it is unnecessary to add a light-shielding area or to enlarge the lamp cap for containing the circuit board 46, thereby increasing the light-permeable area of the cold cathode illumination apparatus 4. In addition, the circuit board 46 can connect to the strip element 45 by wedging, adhering or embedding, for example. As shown in FIG. 6B, the circuit board 46 is wedged in a guiding trench 452 of the strip element 45. The guiding trench 452 of the strip element 45 can assist to position the circuit board 46.

The voltage transforming element 43 and the CCFL 44 are disposed at two opposite sides of the circuit board 46. The voltage transforming element 43 is electrically connected to the electrical connection elements 42 through the circuit board 46. The voltage transforming element 43 can electrically connect to the circuit board 46 through a wire or by direct welding, and the circuit board 46 can also electrically connect to the electrode pins 422 of the electrical connection elements 42 through a wire or by direct welding.

The supporting element 47 is disposed on the strip element 45 and supports the CCFL 44. The number of the supporting element(s) 47 can be one or more. In the embodiment, there are four supporting elements 47, for example.

Therefore, the cold cathode illumination apparatus 4 can be directly connected to the lamp base B having a present electronic ballast, and receive the high frequency power outputted from the electronic ballast. In other words, if the electronic ballast is disposed on the lamp base of the conventional HCFL, the HCFL can be directly replaced by the cold cathode illumination apparatus 4 of the embodiment. On the other hand, if the conventional electromagnetic ballast is disposed on the lamp base of the HCFL, an inverter may be added in the cold cathode illumination apparatus 4 and electrically connected to the voltage transforming element 43, or an inverter is used to replace the voltage transforming element 43 (i.e. the voltage transforming element 43 is a part of the inverter), thereby achieving the direct replacement of the HCFL by altering the circuit. In addition, the inverter is capable of dimming control, so that the cold cathode illumination apparatus 4 of the embodiment has dimming function.

In addition, the strip element 45 has a reflective surface 451, so the cold cathode illumination apparatus 4 can emit light to the single side, thereby decreasing the light emitted to the lamp base B and improving the light usage efficiency.

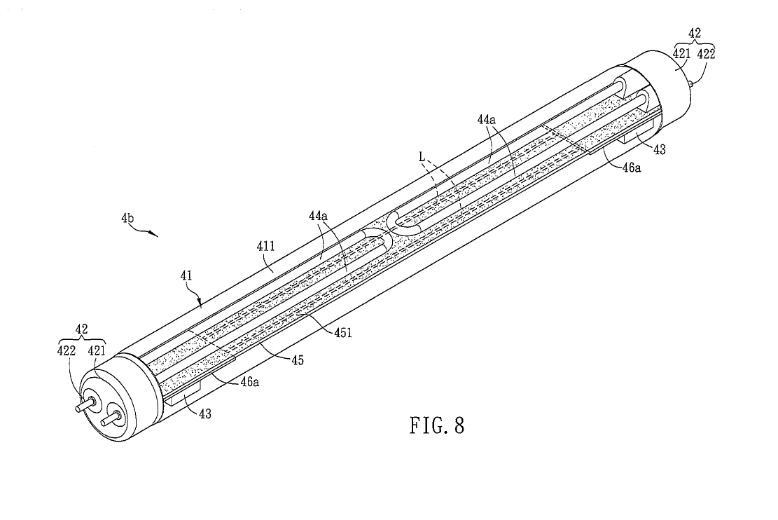

As shown in FIG. 7, it shows another aspect of the cold cathode illumination apparatus according to the embodiment. The cold cathode illumination apparatus 4a can further include an inverter 49 which is directly disposed in the tube 41 and electrically connected to the voltage transforming element 43. The strip element 45a is a circuit board. The voltage transforming element 43 and the inverter 49 are electrically connected to and disposed on the strip element 45a, and they are disposed at the side opposite to the CCFL 44.

In general, the light steel frames are commonly used for the office illumination. The light steel frame usually includes four HCFLs and a lamp base, and each HCFL needs to cooperate with a conventional electromagnetic ballast.

The cold cathode illumination apparatus 4a has an inverter 49 disposed in the tube 41, so when the HCFL is directly replaced by the cold cathode illumination apparatus 4a of the embodiment, the conventional electromagnetic ballast can be removed or remained, thereby not only saving the cost of altering the circuit but also making users more convenient in self-installation. Besides, the reflective surface 451 of the strip element 45a can improve the unit illumination of the cold cathode illumination apparatus 4a. Comparing with the HCFL of the same illumination, the cold cathode illumination apparatus 4a of the embodiment can have less power consumption.

FIG. 8 is a schematic view of another aspect of the cold cathode illumination apparatus of the embodiment. The cold cathode illumination apparatus 4b can have two circuit boards 46a and two voltage transforming elements 43. The voltage transforming elements 43 and the circuit boards 46a are disposed at two ends of the tube 41 respectively. The circuit boards 46a are electrically connected to each other through a wire L. In the embodiment, the circuit boards 46a are electrically connected to each other through two wires L, for example.

Besides, the cold cathode illumination apparatus 4b can have plural CCFLs 44a. In the embodiment, there are two U-shaped CCFLs 44a disposed oppositely, thereby further improving the illumination of the cold cathode illumination apparatus 4b. To be noted, the cold cathode illumination apparatus 4b can be dual-ends power feeding. In this case, both of the electrical connection elements 42 are for power feeding.

To be noted, it is unrestricted on the style, the amount and the arrangement of the CCFL 44a, which can be designed variably according to different demands. For example, the plural U-shaped CCFLs can be stacked to each other.

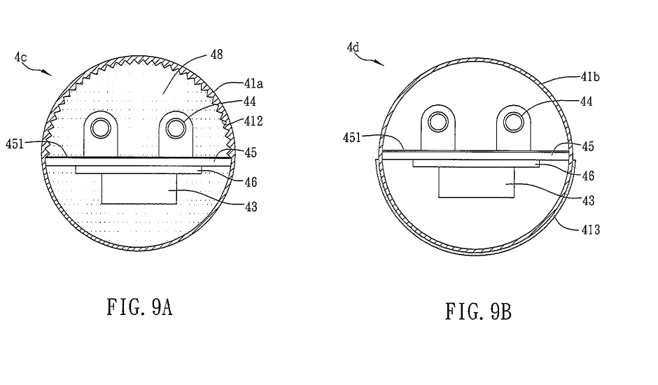

FIG. 9A is a sectional view of another aspect of the cold cathode illumination apparatus according to the embodiment. The tube 41a of the cold cathode illumination apparatus 4c can have a optical structure 412 which can be, for example, a micro-structure (such as micro-lens or a micro-prism) to enhance the directionality of the light, or the tube 41a can have a scattering surface (formed by sand blast) or have plural scattering particles doped therein, so as to make the light emitted from the cold cathode illumination apparatus 4c more uniform.

Besides, the cold cathode illumination apparatus 4c can further have a gas 48 which may be inert gas, nitrogen, or carbon dioxide for example. The gas 48 is filled in the tube 41a to avoid arc discharge which produces ozone, so as to extend the lifespan of the cold cathode illumination apparatus 4c.

FIG. 9B is a sectional view of another aspect of the cold cathode illumination apparatus according to the embodiment. The tube 41b of the cold cathode illumination apparatus 4d can have a reflective surface 413 which can be a reflective layer or a reflective sheet, for example. The reflective surface can decrease the light emitted to the lamp base of the cold cathode illumination apparatus 4d, so as to improve the illumination.

### Fourth Embodiment

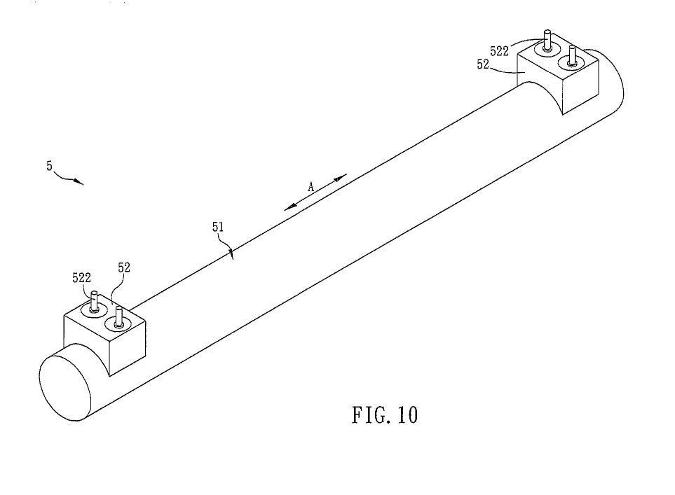

FIG. 10 is a schematic view of the cold cathode illumination apparatus 5 according to the fourth embodiment. The cold cathode illumination apparatus 5 includes a tube 51, an electrical connection element 52, a voltage transforming element, a CCFL and a strip element. To be noted, for clearly showing the electrical connection element 52, the voltage transforming element (and/or inverter), the CCFL and the strip element in the tube 51 are not shown in FIG. 10. In practice, the voltage transforming element, the CCFL and the strip element are still in the tube 51, and the tube 51 is at least partially light-permeable. Besides, the features of the tube 51, the voltage transforming element, the CCFL and the strip element are illustrated clearly as the above embodiments, so the detailed descriptions thereof are omitted.

The electrical connection element 52 is disposed at one end of the tube 51 and can have two electrode pins 522 which are exposed to the electrical connection element 52. The extending direction of the electrode pins 522 is perpendicular to a length direction A of the tube 51.

Comparing with the prior art, the lamp cap is omitted in the connection of the electrical connection element 52 and the tube 51, thereby increasing the lighting area of the cold cathode illumination apparatus 5 and capable of making a continuous light source when the plural cold cathode illumination apparatuses 5 are disposed serially.

In summary, the cold cathode illumination apparatus according to the invention has a tube in which at least one CCFL is disposed. Because the electrode of the CCFL is not made of wolfram, the lighting up of the CCFL can be prompter than that of HCFL. In addition, the CCFL has more advantages, such as long lifespan, and capability of dimming control and ability to turn on and off frequently. Furthermore, the transformer, instead of the high frequency inverter, is disposed in the tube so as to reduce the volume of the tube and avoid the heat producing by the inverter. Furthermore, the cold cathode illumination apparatus can be driven by the AC power. For example, the cold cathode illumination apparatus can be directly connected to the present electronic ballast, and receive the high frequency power outputted from the electronic ballast. In other words, if the electronic ballast is disposed on the lamp base of the conventional HCFL, the HCFL can be directly replaced by the cold cathode illumination apparatus, thereby enhancing the usage convenience and saving the cost of altering the related circuit. On the other hand, if the conventional electromagnetic ballast is installed on the lamp base of the HCFL, an inverter may be added in the cold cathode illumination apparatus and electrically connected to the voltage transforming element, or an inverter may be used to replace the voltage transforming element (i.e. the voltage transforming element is a part of the inverter), thereby achieving the direct replacement of the HCFL by altering the circuit. Besides, the inverter is capable of dimming control, so that the cold cathode illumination apparatus has dimming function.

Besides, the voltage transforming element (or inverter) is disposed in the light-transmissible area of the tube, so it is unnecessary to add a light-shielding area for containing the voltage transforming element, thereby increasing the light-permeable area of the tube and improving the illumination of the cold cathode illumination apparatus. The reflective surface of the string element can reflect the downward light emitted by the CCFL to the upside so as to further enhance the illumination of the cold cathode illumination apparatus.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A cold cathode illumination apparatus applied with an alternative current, comprising:
a tube, at least a part of which is light-permeable;
at least an electrical connection element disposed at one end of the tube;
a voltage transforming element disposed in the tube and electrically connected with the electrical connection element;
a cold cathode fluorescent lamp (CCFL) disposed in the tube and electrically connected with the voltage transforming element; and
a strip element disposed along and in the tube, wherein the CCFL connects to the strip element, the strip element has a reflective surface, and the CCFL is disposed above the reflective surface.

2. The cold cathode illumination apparatus as recited in claim 1, wherein a cross-section of the tube is circular, semicircular, elliptic, square, rectangular or polygonal.

3. The cold cathode illumination apparatus as recited in claim 1, wherein when there are two electrical connection elements, the electrical connection elements are disposed at two ends of the tube respectively.

4. The cold cathode illumination apparatus as recited in claim 1, wherein the electrical connection element has a lamp cap and two electrode pins, the electrode pins are fixed to the lamp cap, and the lamp cap and the tube are connected tightly.

5. The cold cathode illumination apparatus as recited in claim 1, wherein the electrical connection element has two electrode pins, and the extending direction of the electrode pins is substantially perpendicular to a length direction of the tube.

6. The cold cathode illumination apparatus as recited in claim 1, wherein the tube has a light-permeable portion, and the voltage transforming element is disposed corresponding to the light-permeable portion.

7. The cold cathode illumination apparatus as recited in claim 1, wherein the strip element has a circuit layer, and the voltage transforming element electrically connects to the circuit layer.

8. The cold cathode illumination apparatus as recited in claim 1, wherein the voltage transforming element is a transforming element of an inverter.

9. The cold cathode illumination apparatus as recited in claim 1, further comprising:
an inverter disposed in the tube and electrically connected to the voltage transforming element.

10. The cold cathode illumination apparatus as recited in claim 1, further comprising:
at least a circuit board disposed in the tube.

11. The cold cathode illumination apparatus as recited in claim 10, wherein when there are two circuit boards, the circuit boards are disposed at two ends of the tube respectively.

12. The cold cathode illumination apparatus as recited in claim 11, wherein the circuit boards are electrically connected to each other through a wire.

13. The cold cathode illumination apparatus as recited in claim 10, wherein the voltage transforming element and the CCFL are disposed at two opposite sides of the circuit board, and the voltage transforming element is electrically connected with the electrical connection element through the circuit board.

14. The cold cathode illumination apparatus as recited in claim 10, further comprising:
an inverter disposed on the circuit board and electrically connected with the voltage transforming element.

15. The cold cathode illumination apparatus as recited in claim 1, wherein the voltage transforming element and the CCFL are disposed at two opposite sides of the strip element.

16. The cold cathode illumination apparatus as recited in claim 1, wherein the strip element is light-permeable.

17. The cold cathode illumination apparatus as recited in claim 1, wherein the strip element is fixed with the electrical connection element.

18. The cold cathode illumination apparatus as recited in claim 1, further comprising:
a supporting element disposed on the strip element and supporting the CCFL.

19. The cold cathode illumination apparatus as recited in claim 1, further comprising:
a gas filled in the tube.

20. The cold cathode illumination apparatus as recited in claim 1, wherein the strip element has at least a light-adjusting portion and a main body, and an included angle is formed between the light-adjusting portion and the main body.
